(19) United States
(12) Patent Application Publication
(10) Pub. No.: US 2025/0010752 A1
(43) Pub. Date: Jan. 9, 2025

(54) CHARGING SYSTEM

(71) Applicant: SUBARU CORPORATION, Tokyo (JP)

(72) Inventor: Takumu SUGIYAMA, Tokyo (JP)

(21) Appl. No.: 18/889,720

(22) Filed: Sep. 19, 2024

Related U.S. Application Data
(63) Continuation of application No. PCT/JP2023/025037, filed on Jul. 5, 2023.

(51) Int. Cl. B60L 53/63

(52) U.S. Cl. CPC B60L 53/63; B60L 2240/72; B60L 2250/12

(57) ABSTRACT

A charging system includes: a vehicle including an in-vehicle battery and a control device; and a charging facility capable of charging the vehicle. The control device determines whether a power saving request has been issued to a region to which the charging facility belongs. When the power saving request is determined to have been issued, the control device encourages an occupant of the vehicle to select whether to cooperate with the power saving request. When a selection result indicating cooperation with the power saving request is acquired, the control device encourages the occupant of the vehicle to select whether to charge the vehicle with a first limited charging amount or a second limited charging amount. The control device permits limitation of the charging amount with which the vehicle is charged from the charging facility, based on selected one of the first limited charging amount and the second limited charging amount.

### CROSS REFERENCE TO RELATED APPLICATIONS

This application is continuation of International Application No. PCT/JP2023/025037, filed on Jul. 5, 2023, the entire contents of which are hereby incorporated by reference.

### BACKGROUND

The disclosure relates to a charging system that performs charging.

For example, Japanese Unexamined Patent Application Publication (JP-A) No. 2011-13893 discloses a technique for forecasting a possibility that a vehicle will be charged at a charging station. In JP-A 2011-13893, the lower a battery remaining amount of the vehicle is, the higher the forecast charging possibility is, and the higher the battery remaining amount is, the lower the forecast charging possibility is.

### SUMMARY

An aspect of the disclosure provides a charging system including: a vehicle including an in-vehicle battery and a control device; and a charging facility capable of charging the vehicle. The control device includes one or more processors and one or more memories coupled to the one or more processors. The one or more processors are configured to perform processing including: determining whether a power saving request has been issued to a region to which the charging facility belongs; when the power saving request is determined to have been issued, encouraging an occupant of the vehicle to perform a selection to select whether to cooperate with the power saving request; when a result of the selection indicating cooperation with the power saving request is acquired, encouraging the occupant of the vehicle to select whether to charge the vehicle with a first limited charging amount, which is a charging amount with which the vehicle is charged from the charging facility and which is limited based on the power saving request differently from a case of not cooperating with the power saving request, or a second limited charging amount, which is a charging amount more limited than the first limited charging amount; and permitting limitation of the charging amount with which the vehicle is charged from the charging facility, based on selected one of the first limited charging amount and the second limited charging amount.

An aspect of the disclosure provides a charging system including: a vehicle including an in-vehicle battery and a control device; and a charging facility capable of charging the vehicle. The control device includes one or more processors and one or more memories coupled to the one or more processors. The one or more processors are configured to perform processing including: receiving setting of a target point of traveling; setting a route from a current point to the target point; determining whether a power saving request has been issued to a region to which the charging facility belongs; when the power saving request is determined to have been issued, encouraging an occupant of the vehicle to perform a selection to select whether to cooperate with the power saving request; and when a result of the selection indicating cooperation with the power saving request is acquired, permitting limitation of a charging amount with which the vehicle is charged from the charging facility differently from a case of not cooperating with the power saving request. The one or more processors are configured to perform processing including: in the setting the route, determining whether the vehicle is to be charged in a middle of the route; when the vehicle is determined to be charged in the middle of the route, specifying a via-charging facility, which is the charging facility in the middle of the route; determining whether the power saving request has been issued to a region to which the via-charging facility belongs; when the power saving request is determined to have been issued, encouraging the occupant of the vehicle to select whether to cooperate with the power saving request; and when the result of the selection indicating the cooperation with the power saving request is acquired, permitting the limitation of the charging amount with which the vehicle is charged from the via-charging facility as compared with the case of not cooperating with the power saving request. The one or more processors are configured to perform processing including: when the power saving request is determined to have been issued to the region to which the via-charging facility belongs, determining whether the vehicle is able to arrive at the target point even when the vehicle is charged from the via-charging facility with the charging amount limited based on the power saving request; and when the vehicle is determined to be not able to arrive at the target point by the charging with the limited charging amount, not permitting the limitation of the charging amount with which the vehicle is charged from the via-charging facility even when the power saving request is determined to have been issued.

An aspect of the disclosure provides a charging system including: a vehicle including an in-vehicle battery and a control device; and a charging facility capable of charging the vehicle. The control device includes one or more processors and one or more memories coupled to the one or more processors. The one or more processors are configured to perform processing including: receiving setting of a target point of traveling; setting a route from a current point to the target point; determining whether a power saving request has been issued to a region to which the charging facility belongs; when the power saving request is determined to have been issued, encouraging an occupant of the vehicle to perform a selection to select whether to cooperate with the power saving request; and when a result of the selection indicating cooperation with the power saving request is acquired, permitting limitation of a charging amount with which the vehicle is charged from the charging facility differently from a case of not cooperating with the power saving request. The one or more processors are configured to perform processing including: in the setting the route, determining whether the vehicle is to be charged in a middle of the route; when the vehicle is determined to be charged in the middle of the route, specifying a via-charging facility, which is the charging facility in the middle of the route; determining whether the power saving request has been issued to a region to which the via-charging facility belongs; when the power saving request is determined to have been issued, encouraging the occupant of the vehicle to select whether to cooperate with the power saving request; and when the result of the selection indicating the cooperation with the power saving request is acquired, permitting the limitation of the charging amount with which the vehicle is charged from the via-charging facility differently from the case of not cooperating with the power saving request. The one or more processors are configured to perform processing including: when charging is specified to be performed at via-charging facilities including the via-charging facility, at a via-charging facility other than a via-charging facility closest to the target point along the route among the via-charging facilities, not permitting the limitation of the charging amount with which the vehicle is charged from the via-charging facility even when the power saving request is determined to have been issued.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating an example of a configuration of a charging system according to an embodiment of the disclosure;

FIG. 2 illustrates an example of a screen for selecting whether to cooperate with a power saving request;

FIG. 3 is a diagram illustrating an example in which via-charging facilities are specified up to a target point;

FIG. 4 is a flowchart illustrating an operation flow of a vehicle controller;

FIG. 5 is a flowchart illustrating a flow of a target point charging reservation process;

FIG. 6 is a flowchart illustrating a flow of a via-charging-facility charging reservation process;

FIG. 7 is a flowchart illustrating the flow of the via-charging-facility charging reservation process;

FIG. 8 is a flowchart illustrating the flow of the via-charging-facility charging reservation process;

FIG. 9 is a flowchart illustrating a process flow at a start of charging; and

FIG. 10 is a flowchart illustrating a flow of a jump-in charging process.

### DETAILED DESCRIPTION

A vehicle such as an electric vehicle having an electric motor as a driving source may attempt to charge an in-vehicle battery at a charging facility such as a charging station.

When a demand for electric power is tight in a region covered by an electric power company, the electric power company may issue a power saving request to the region covered by the electric power company. When the power saving request is issued, it is desirable to limit an amount of electric power used in cooperation with the power saving request in order to suppress the demand for electric power.

Therefore, it is desirable to provide a charging system capable of appropriately performing charging even when the power saving request is issued.

Hereinafter, an embodiment of the disclosure will be described in detail with reference to the accompanying drawings. Specific dimensions, materials, numerical values, and the like illustrated in the embodiment are merely examples for facilitating understanding of the disclosure, and do not limit the disclosure unless otherwise specified. In this specification and the drawings, elements having substantially the same functions and configurations are denoted by the same reference numerals to omit redundant description, and elements not directly related to the disclosure are not illustrated.

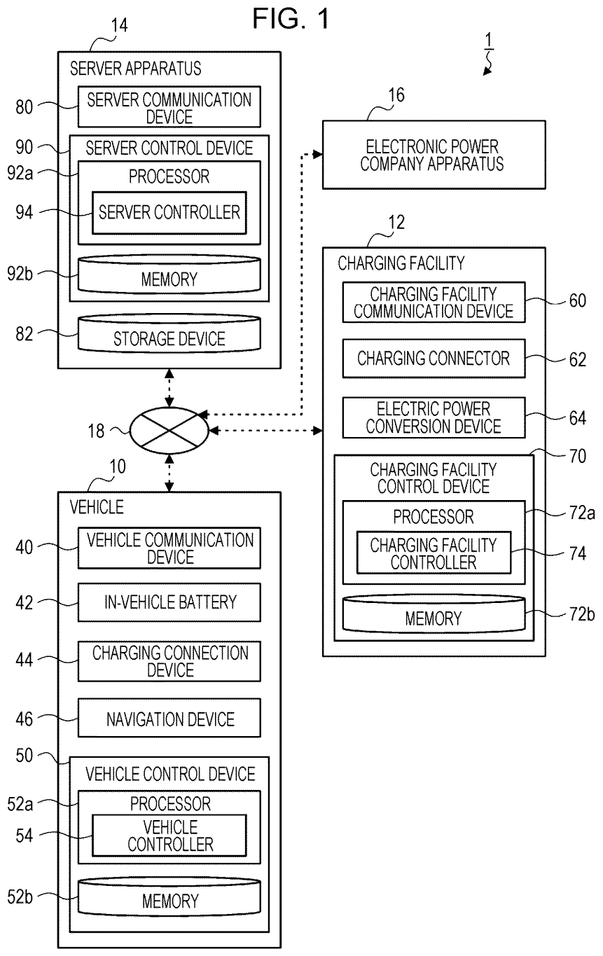

FIG. 1 is a block diagram illustrating an example of a configuration of a charging system 1 according to the embodiment. The charging system 1 includes a vehicle 10, a charging facility 12, a server apparatus 14, and an electric power company apparatus 16. The vehicle 10 is an electric vehicle having an in-vehicle battery that supplies electric power to a driving source. Note that the vehicle 10 may be a hybrid electric vehicle.

As will be described in detail later, the charging facility 12 is configured to be able to charge the in-vehicle battery of the vehicle 10. Hereinafter, charging of the in-vehicle battery may be simply referred to as charging. The expression “charging of the vehicle 10” therefore refers to the charging of the in-vehicle battery of the vehicle 10.

For example, the charging facility 12 is installed in association with a predetermined position on a travel road. The travel road is various roads on which the vehicle can travel. For example, the charging facility 12 may be installed in a rest area on an expressway as the travel road. In addition, the charging facility 12 may be installed at a home of an occupant of the vehicle.

The server apparatus 14 is, for example, a cloud server or the like, and can manage charging facilities 12.

The electric power company apparatus 16 is a server apparatus managed by an electric power company.

The vehicle 10, the charging facility 12, the server apparatus 14, and the electric power company apparatus 16 are configured to be able to communicate with each other through, for example, a communication network 18.

When a demand for electric power is tight in a region covered by the electric power company, the electric power company can issue a power saving request for encouraging power saving to the region covered by the electric power company. At this time, the electric power company apparatus 16 in the region where the demand for electric power is tight may broadcast information indicating the power saving request through the communication network 18. For example, the power saving request may be issued in a region division such as Kanto, Kansai, or Chubu, or may be issued in a region division such as a prefecture, a city, a town, or a village. Hereinafter, for convenience of description, a time when the power saving request is issued may be referred to as a power saving request time. A time when the power saving request is not issued may be referred to as a normal time.

Each apparatus that has received the power saving request desirably limits an amount of electric power used in cooperation with the power saving request in order to suppress the demand for electric power.

Therefore, in the charging system 1 of the embodiment, a charging amount, which is an amount of electric power supplied from the charging facility 12 to the vehicle 10, can be limited in response to the power saving request issued by the electric power company. At this time, in the charging system 1 of the embodiment, the occupant of the vehicle 10 is allowed to select whether to cooperate with the power saving request, and the charging amount is limited when an intention to cooperate with the power saving request is confirmed. Hereinafter, a configuration and an operation of the charging system 1 of the embodiment will be described in detail.

The vehicle 10 includes a vehicle communication device 40, an in-vehicle battery 42, a charging connection device 44, a navigation device 46, and a vehicle control device 50. The vehicle communication device 40 can establish communication with the charging facility 12 and the server apparatus 14 through the communication network 18.

The in-vehicle battery 42 is, for example, a chargeable and dischargeable secondary battery, such as a lithium-ion battery. The charging connection device 44 has a charging port exposed to the outside, and is configured such that a charging connector 62 of the charging facility 12, which will be described later, can be connected thereto. The charging connection device 44 functions as a connector that electrically connects the charging facility 12 and the in-vehicle battery 42.

The navigation device 46 can specify a position of the vehicle 10 using a global positioning system (GPS). The navigation device 46 includes a display device capable of displaying various kinds of information, such as map information, a traveling route, and the position of the vehicle 10. The map information may include information on the travel road and information on an installation position of the charging facility 12.

The navigation device 46 also functions as a notifier that notifies the occupant of information related to the vehicle 10 and an operator that receives an operation of the occupant. For example, the navigation device 46 can display information related to the charging of the vehicle 10 on the display device in addition to or instead of the various kinds of information described above. In addition, the navigation device 46 can receive an operation input of the occupant with respect to an option regarding the charging of the vehicle 10 through, for example, a touch panel or the like provided in the navigation device 46.

The vehicle control device 50 includes at least one processor 52a and at least one memory 52b coupled to the at least one processor 52a. The memory 52b includes a read-only memory (ROM) in which a program and the like are stored and a random-access memory (RAM) as a work area. The processor 52a controls the entirety of the vehicle 10 in cooperation with the program included in the memory 52b. The processor 52a also functions as a vehicle controller 54 by executing the program. The vehicle controller 54 executes various processes related to the charging of the vehicle 10.

The charging facility 12 includes a charging facility communication device 60, the charging connector 62, a power conversion device 64, and a charging facility control device 70. The charging facility communication device 60 can establish communication with the server apparatus 14 and the vehicle 10 through the communication network 18.

The charging connector 62 is configured to be connectable to the charging connection device 44 of the vehicle 10. For example, the power conversion device 64 converts electric power of a commercial power supply, and supplies the electric power to the vehicle 10 through the charging connector 62 and the charging connection device 44. Under the control of the charging facility control device 70, the power conversion device 64 can change the charging amount, which is the amount of electric power to be supplied to the vehicle 10, stepwise or continuously. In this way, the in-vehicle battery 42 can be charged.

The charging facility control device 70 includes at least one processor 72a and at least one memory 72b coupled to the at least one processor 72a. The memory 72b includes a ROM in which a program and the like are stored and a RAM as a work area. The processor 72a controls the entirety of the charging facility 12 in cooperation with the program included in the memory 72b. The processor 72a also functions as a charging facility controller 74 by executing the program. The charging facility controller 74 executes various processes related to the charging of the vehicle 10.

The server apparatus 14 includes a server communication device 80, a storage device 82, and a server control device 90. The server communication device 80 can establish communication with the charging facility 12 and the vehicle 10 through the communication network 18.

The storage device 82 is constituted by a non-volatile storage element. Note that the non-volatile storage element may include an electrically readable and writable non-volatile storage element such as a flash memory, for example.

The server control device 90 includes at least one processor 92a and at least one memory 92b coupled to the at least one processor 92a. The memory 92b includes a ROM in which a program and the like are stored and a RAM as a work area. The processor 92a controls the entirety of the server apparatus 14 in cooperation with the program included in the memory 92b. The processor 92a also functions as a server controller 94 by executing the program. The server controller 94 executes various processes related to the charging of the vehicle 10.

Any vehicle 10 as above having an electric motor as a driving source attempts to charge the in-vehicle battery 42 at the charging facility 12 as a state of charge (SOC) of the in-vehicle battery 42 decreases. For example, when any vehicle 10 is traveling on the expressway as the travel road, the vehicle 10 may stop at the rest area and charge the in-vehicle battery 42 at the charging facility 12 in the rest area.

Here, the charging system 1 is configured to be able to reserve the charging of the vehicle 10 at the charging facility 12 before the vehicle 10 arrives at the charging facility 12. For example, the vehicle controller 54 requests the server apparatus 14 to reserve the charging of the vehicle 10 by the charging facility 12, and the server apparatus 14 reserves the charging by the charging facility 12 in response to the reservation request. The server apparatus 14 manages the reservation of the charging for each charging facility 12. Note that the vehicle controller 54 may request the charging facility 12 that performs the charging to reserve the charging, and the charging facility 12 may reserve the charging individually. Hereinafter, for convenience of description, an expression that the vehicle controller 54 reserves the charging of the vehicle 10 may be used in the same meaning as an expression that the vehicle controller 54 requests the reservation of the charging.

For example, at a timing at which any vehicle 10 has not arrived at the charging facility 12, the vehicle 10 forecasts an arrival time at the charging facility 12, and reserves a desired charging time based on the arrival time. Note that a start time of the reserved charging may be referred to as a reserved start time, and an end time of the reserved charging may be referred to as a reserved end time. In this way, when any vehicle 10 arrives at the charging facility 12, the in-vehicle battery 42 can be charged from the reserved start time without waiting for the charging.

The vehicle controller 54 can acquire a current point, which is a current position of the vehicle 10, by using the GPS of the navigation device 46. The vehicle controller 54 can receive setting of a target point of traveling through the navigation device 46. For example, the occupant of the vehicle 10 can input the target point by operating the touch panel of the navigation device 46. The vehicle controller 54 can set a route from the current point to the target point by referring to the map information through the navigation device 46.

Hereinafter, a current amount of electric power remaining in the in-vehicle battery 42 may be referred to as a current battery remaining amount. In addition, an amount of electric power necessary to travel along the route from the current point to the target point may be referred to as a necessary electric power amount. When the current battery remaining amount is greater than or equal to the necessary electric power amount, it is possible to travel from the current point to the target point.

Here, the rest area or the like in which the charging facility 12 is installed may be set as the target point. The vehicle controller 54 determines whether the charging facility 12 is installed at the target point when the route is set. When it is determined that the charging facility 12 is installed at the target point, the vehicle controller 54 reserves the charging of the vehicle 10 at the charging facility 12 at the target point.

When reserving the charging at the charging facility 12 at the target point, the vehicle controller 54 determines whether a power saving request has been issued to a region to which the charging facility 12 at the target point belongs. For example, the vehicle controller 54 may determine whether the power saving request has been issued by directly receiving information indicating the power saving request from the electric power company apparatus 16. The vehicle controller 54 may alternatively inquire of the electric power company apparatus 16 whether the power saving request has been issued. In addition, the server apparatus 14 may receive the information indicating the power saving request from the electric power company apparatus 16, and the vehicle controller 54 may determine whether the power saving request has been issued by communicating with the server apparatus 14.

When it is determined that the power saving request has been issued to the region to which the charging facility 12 at the target point belongs, the vehicle controller 54 encourages the occupant of the vehicle 10 to select whether to cooperate with the power saving request. For example, the vehicle controller 54 displays a screen for selecting whether to cooperate with the power saving request on the display device or the like of the navigation device 46.

When a selection result indicating the cooperation with the power saving request is acquired, the vehicle controller 54 permits the limitation of the charging amount with which the vehicle 10 is charged from the charging facility 12, differently from the case of not cooperating with the power saving request. The vehicle controller 54 reserves the charging with the limited charging amount at the charging facility 12 at the target point.

For example, in the normal time, the charging facility 12 can charge the vehicle 10 with a maximum charging amount, which is a maximum value of the amount of electric power that can be supplied from the charging facility 12 to the vehicle 10 in one time of charging. Also, in the normal time, the charging facility 12 may charge the vehicle 10 with a charging amount that is set in advance by the occupant of the vehicle 10.

When the occupant of the vehicle 10 selects not to cooperate with the power saving request, the vehicle controller 54 may permit the charging with the same charging amount as that in the normal time described above. That is, when the vehicle 10 is actually charged after the occupant selects not to cooperate with the power saving request, the charging facility 12 may charge the vehicle 10 with the maximum charging amount of the charging facility 12.

On the other hand, when the occupant selects to cooperate with the power saving request, the vehicle controller 54 permits the limitation of the charging amount such that the charging amount is at least smaller than the maximum charging amount of the charging facility 12. That is, when the vehicle 10 is actually charged after the occupant selects to cooperate with the power saving request, the charging facility 12 can charge the vehicle 10 with the charging amount that is at least smaller than the maximum charging amount of the charging facility 12. In addition, when the occupant selects to cooperate with the power saving request, the vehicle controller 54 may permit the limitation of the charging amount such that the charging amount is smaller than the charging amount that is set in advance by the occupant of the vehicle 10. That is, when the vehicle 10 is actually charged after the occupant selects to cooperate with the power saving request, the charging facility 12 can charge the vehicle 10 with the charging amount smaller than the charging amount that is set in advance by the occupant of the vehicle 10. For example, the charging facility 12 may perform the charging with a charging amount of a predetermined ratio with respect to the charging amount in the normal time, such as a charging amount of 50% of the charging amount in the normal time.

In this way, when the power saving request is issued and the occupant's intention to cooperate with the power saving request is confirmed, the limitation of the charging amount from the charging facility 12 to the vehicle 10 is permitted, and accordingly, the charging facility 12 can appropriately cooperate with the power saving request. At this time, the occupant of the vehicle 10 can also make a social contribution by cooperating with the power saving request at the charging facility 12. As a result, the charging system 1 can improve the demand for electric power in the region to which the charging facility 12 belongs. For example, the charging system 1 can prevent the demand for electric power from becoming tighter and developing into a more serious situation such as a planned power outage.

In addition, by allowing the occupant of the vehicle 10 to select whether to cooperate with the power saving request, the vehicle controller 54 can permit the charging with the charging amount in the normal time even when the power saving request is issued. Accordingly, the charging system 1 can avoid a situation in which the traveling intended by the occupant is hindered by the limitation of the charging amount due to the power saving request.

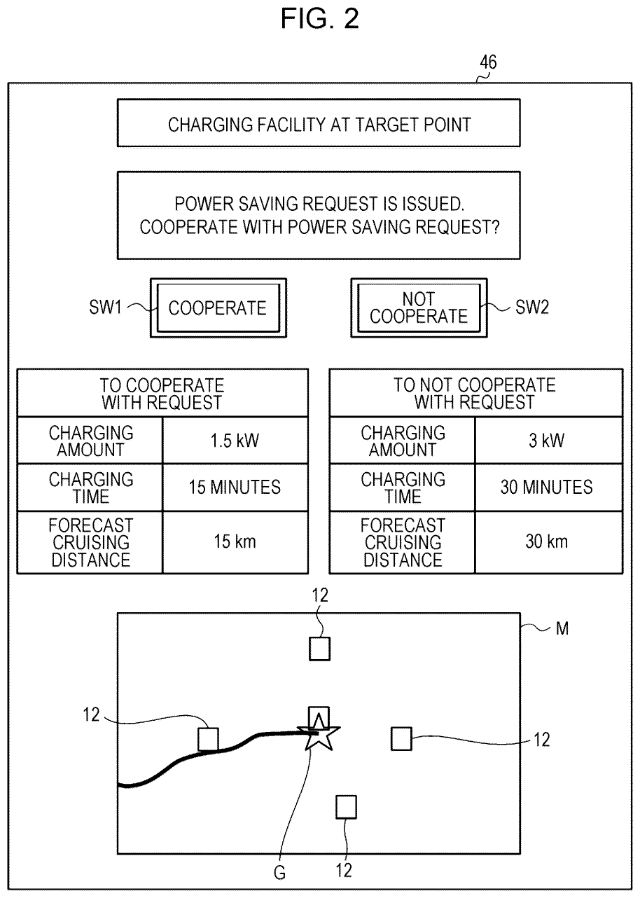

FIG. 2 illustrates an example of the screen for selecting whether to cooperate with the power saving request. In the example in FIG. 2, the selection screen is displayed on the display device of the navigation device 46.

As illustrated in FIG. 2, on the selection screen, for example, a software button SW1 indicating “cooperate” and a software button SW2 indicating “not cooperate” are displayed. The software button SW1 of “cooperate” can receive selection of an intention to cooperate with the power saving request through the touch panel. The software button SW2 of “not cooperate” can receive selection of an intention not to cooperate with the power saving request through the touch panel. That is, the software button SW1 and the software button SW2 function as selection operators for receiving selection of whether to cooperate with the power saving request. The occupant can operate the software button SW1 of “cooperate” or the software button SW2 of “not cooperate”.

As illustrated in FIG. 2, the selection screen displays information of the charging amount, the charging time, and a forecast cruising distance on the assumption to cooperate with the power saving request, and information of the charging amount, the charging time, and the forecast cruising distance on the assumption to not cooperate with the power saving request. The charging amount on the assumption to not cooperate with the power saving request is the charging amount in the normal time. The charging amount on the assumption to cooperate with the power saving request is the charging amount limited due to the power saving request.

Hereinafter, for convenience of description, the charging amount, the charging time, and the forecast cruising distance may be collectively referred to as charging information.

The forecast cruising distance can be derived based on average electric power consumption, which is a unit travel distance per electric power consumption in the vehicle. For example, the forecast cruising distance is derived by multiplying a value, obtained by adding the current battery remaining amount and the charging amount by the average electric power consumption (forecast cruising distance=(current battery remaining amount+charging amount)×average electric power consumption). The average electric power consumption is derived, for example, by averaging the electric power consumption in previous driving cycles, and the electric power consumption is derived from the power consumption during one driving cycle from ready-on to ready-off and the travel distance at that time.

In this way, the charging amount, the charging time, and the forecast cruising distance are displayed both in the case of cooperating with the power saving request and in the case of not cooperating with the power saving request, and accordingly, the occupant can easily determine whether to cooperate with the power saving request.

Note that the disclosure is not limited to the embodiment in which the charging information is displayed, and the display of the charging information may be omitted as long as at least the selection operators are displayed on the selection screen.

In addition, the disclosure is not limited to the embodiment in which all of the charging amount, the charging time, and the forecast cruising distance are displayed on the selection screen, and any one or more of the charging amount, the charging time, and the forecast cruising distance may be displayed on the selection screen.

In addition, the disclosure is not limited to the embodiment in which both the charging information on the assumption to cooperate with the power saving request and the charging information on the assumption to not cooperate with the power saving request are displayed on the selection screen. Any one or more of pieces of the information of the charging amount, the charging time, and the forecast cruising distance on the assumption to cooperate with the power saving request may be displayed on the selection screen, and the display of the charging information on the assumption to not cooperate with the power saving request may be omitted.

In addition, as illustrated in FIG. 2, map information M of a predetermined range including the target point exemplified by a star G may be displayed on the selection screen. The target point and the charging facilities 12 around the target point may be displayed in the map information M of the predetermined range.

By the charging facilities 12 around the target point being displayed on the selection screen, the occupant of the vehicle 10 can easily make a travel plan after charging at the charging facility 12 at the target point, and can more easily determine whether to cooperate with the power saving request.

Note that the display of the target point and the charging facilities 12 around the target point may be omitted.

If the current battery remaining amount is smaller than the necessary electric power amount when the route is set, the current battery remaining amount is not enough to arrive at the target point. In such a case, it is necessary to stop at the charging facility 12 in the middle of the route between the current point and the target point to charge the vehicle 10. Hereinafter, for convenience of description, the charging facility 12 in the middle of the route may be referred to as a via-charging facility.

When the route is set, the vehicle controller 54 determines whether the vehicle 10 is to be charged in the middle of the route. When it is determined that the vehicle 10 is to be charged in the middle of the route, the vehicle controller 54 specifies the via-charging facility in the middle of the route. The vehicle controller 54 reserves the charging of the vehicle 10 at the specified via-charging facility.

When the charging at the via-charging facility is to be reserved, the vehicle controller 54 determines whether the power saving request has been issued to a region to which the via-charging facility belongs. As a specific method for determining whether the power saving request has been issued, it is possible to adopt a method similar to the determination as to whether the power saving request has been issued to the region to which the charging facility 12 at the target point belongs.

When it is determined that the power saving request has been issued to the region to which the via-charging facility belongs, the vehicle controller 54 encourages the occupant of the vehicle 10 to select whether to cooperate with the power saving request. For example, the vehicle controller 54 displays the screen for selecting whether to cooperate with the power saving request on the display device of the navigation device 46 or the like.

The selection screen for the via-charging facility may have substantially the same configuration as the selection screen for the charging facility 12 at the target point illustrated in FIG. 2. However, numerical values of the charging information derived for the via-charging facility are displayed.

On the selection screen for the via-charging facility, in addition to or instead of the display of the map information of the target point and the charging facilities 12 around the target point, map information of a point at which the via-charging facility is installed and the charging facilities around the via-charging facility may be displayed.

When a selection result indicating the cooperation with the power saving request in the region to which the via-charging facility belongs is acquired, the vehicle controller 54 permits the limitation of the charging amount with which the vehicle 10 is charged from the via-charging facility, differently from the case of not cooperating with the power saving request.

When the occupant of the vehicle 10 selects not to cooperate with the power saving request, the vehicle controller 54 may permit the charging with the same charging amount as that in the normal time described above.

On the other hand, when the occupant selects to cooperate with the power saving request, the vehicle controller 54 permits the limitation of the charging amount such that the charging amount is at least smaller than the maximum charging amount of the via-charging facility. That is, when the vehicle 10 is actually charged after the occupant selects to cooperate with the power saving request, the via-charging facility can charge the vehicle 10 with the charging amount at least smaller than the maximum charging amount of the via-charging facility. In addition, when the occupant selects to cooperate with the power saving request, the vehicle controller 54 may permit the limitation of the charging amount such that the charging amount is smaller than the charging amount that is set in advance by the occupant of the vehicle 10. That is, when the vehicle 10 is actually charged after the occupant selects to cooperate with the power saving request, the via-charging facility can charge the vehicle 10 with the charging amount smaller than the charging amount that is set in advance by the occupant of the vehicle 10. For example, the via-charging facility may perform the charging with a charging amount of a predetermined ratio with respect to the charging amount in the normal time, such as a charging amount of 50% of the charging amount in the normal time.

In this way, when the power saving request is issued and the occupant's intention to cooperate with the power saving request is confirmed, the limitation of the charging amount of the via-charging facility to the vehicle 10 is permitted, and accordingly, the via-charging facility can appropriately cooperate with the power saving request. At this time, the occupant of the vehicle 10 can also make a social contribution by cooperating with the power saving request at the via-charging facility. As a result, the charging system 1 can improve the demand for electric power in the region to which the via-charging facility belongs. For example, the charging system 1 can prevent the demand for electric power from becoming tighter and developing into a more serious situation such as a planned power outage.

In addition, by allowing the occupant of the vehicle 10 to select whether to cooperate with the power saving request, the vehicle controller 54 can permit the charging with the charging amount in the normal time even when the power saving request is issued. Accordingly, the charging system 1 can avoid a situation in which the traveling intended by the occupant is hindered by the limitation of the charging amount due to the power saving request.

When it is determined that the power saving request has been issued to the region to which the via-charging facility belongs, the vehicle controller 54 determines whether the vehicle 10 can arrive at the target point even if the vehicle 10 is charged from the via-charging facility with the limited charging amount based on the power saving request.

When it is determined that the charging with the limited charging amount is not enough for the vehicle 10 to arrive at the target point, the vehicle controller 54 does not permit the limitation of the charging amount even when it is determined that the power saving request has been issued. That is, the vehicle controller 54 permits the charging with the charging amount in the normal time.

In this case, the vehicle controller 54 may display, on the display device of the navigation device 46, a message indicating that the limitation of the charging amount is not permitted. In this case, the vehicle controller 54 may not display the selection operators indicating whether to cooperate with the power saving request, and may not allow the occupant to select to cooperate with the power saving request.

In this way, when it is determined that the charging with the limited charging amount is not enough for the vehicle 10 to arrive at the target point, the charging system 1 does not permit the limitation of the charging amount. Accordingly, it is possible to avoid a situation in which the arrival at the target point is not possible when cooperating with the power saving request.

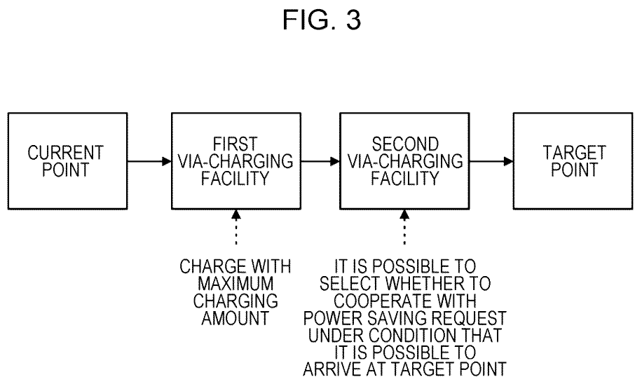

FIG. 3 is a diagram illustrating an example in which via-charging facilities are specified up to the target point. In the example in FIG. 3, a first via-charging facility from the current point is referred to as a first via-charging facility, and a second via-charging facility from the current point is referred to as a second via-charging facility.

When it is assumed that the charging is performed at the first via-charging facility and even the amount of electric power remaining in the in-vehicle battery 42 after the charging is not enough to arrive at the target point, the second via-charging facility as an additional via-charging facility is specified between the first via-charging facility and the target point along the route.

When even the amount of electric power remaining in the in-vehicle battery 42 after charging at the second via-charging facility is not enough to arrive at the target point, an additional via-charging facility is specified between the second via-charging facility and the target point along the route. In this way, one or more via-charging facilities are specified along the route until the vehicle can travel to the target point.

As described above, it is specified that the charging is necessary at the via-charging facilities. Hereinafter, for convenience of description, a via-charging facility closest to the target point along the route among the via-charging facilities may be referred to as a final via-charging facility. In addition, a via-charging facility other than the via-charging facility closest to the target point along the route among the via-charging facilities may be referred to as a non-final via-charging facility. In the example in FIG. 3, the first via-charging facility corresponds to the non-final via-charging facility, and the second via-charging facility corresponds to the final via-charging facility.

As illustrated in FIG. 3, at the non-final via-charging facility, even when it is determined that the power saving request has been issued, the vehicle controller 54 does not permit the limitation of the charging amount. For example, at the non-final via-charging facility, the vehicle controller 54 permits the charging with the maximum charging amount of the non-final via-charging facility.

On the other hand, as illustrated in FIG. 3, the vehicle controller 54 can select whether to cooperate with the power saving request under the condition that the arrival at the target point is possible even when the charging is performed with the limited charging amount at the final via-charging facility. Note that the vehicle controller 54 does not cooperate with the power saving request when the arrival at the target point is not possible if the charging is performed with the limited charging amount at the final via-charging facility.

In this way, in the charging system 1, when the charging is necessary at the via-charging facilities, it is possible to suppress a further increase in the number of via-charging facilities for charging by not permitting the limitation of the charging amount at the non-final via-charging facility. As a result, in the charging system 1, it is possible to suppress a time taken to arrive at the target point from becoming excessively long.

Hereinafter, for convenience of description, the charging amount limited based on the power saving request in cooperation with the power saving request may be referred to as a first limited charging amount. As described above, the first limited charging amount is set to a value at least smaller than the maximum charging amount of the charging facility, and may be set to, for example, 50% of the maximum charging amount.

When cooperating with the power saving request, the vehicle controller 54 may encourage the occupant of the vehicle 10 to select whether to charge the vehicle 10 with the first limited charging amount or a second limited charging amount. The second limited charging amount is a charging amount more limited than the first limited charging amount. Then, the vehicle controller 54 may permit the limitation of the charging amount with which the vehicle 10 is charged from the charging facility 12, based on the selected one of the first limited charging amount and the second limited charging amount. Hereinafter, the first limited charging amount and the second limited charging amount may be collectively referred to as a limited charging amount.

For example, when the charging with the first limited charging amount is performed at the final via-charging facility, at a point in time when the vehicle 10 arrives at the target point, a surplus amount of electric power remains in the in-vehicle battery 42 to further travel from the target point.

In view of this, the second limited charging amount may be set to, for example, a charging amount equal to the amount of electric power necessary for traveling from the final via-charging facility to the target point. In other words, the second limited charging amount may be set to a charging amount such that no surplus amount of electric power remains in the in-vehicle battery 42 when the vehicle 10 arrives at the target point.

When the limitation of the charging amount is permitted in accordance with the second limited charging amount, the charging amount is more limited than when the limitation of the charging amount is permitted in accordance with the first limited charging amount. Therefore, in this embodiment, it is possible to further reduce the amount of electric power used at the charging facility 12. As a result, in this embodiment, it is possible to further increase the effect of the power saving request.

It has been described so far that the charging of the vehicle 10 by the charging facility 12 is reserved when the route is set, and when the cooperation with the power saving request is selected at the time of such reservation, the limitation of the charging amount at the reserved charging facility 12 is permitted.

However, although the power saving request is issued at the time of reservation, the power saving request may be canceled at the start of the charging.

Therefore, the vehicle controller 54 may determine whether the power saving request is present also when the charging is actually started. Accordingly, the vehicle controller 54 can appropriately respond depending on whether the power saving request is issued.

In addition, depending on the occupant, the charging may be performed by directly moving to the charging facility 12 without reservation. Hereinafter, for convenience of description, the charging without reservation may be referred to as jump-in charging.

Also in the jump-in charging, the vehicle controller 54 may determine whether the power saving request is present at the start of the charging. Also in the jump-in charging, when a selection result indicating the cooperation with the power saving request is acquired, the vehicle controller 54 may permit the limitation of the charging amount with which the vehicle 10 is charged from the charging facility 12, differently from the case of not cooperating with the power saving request.

Accordingly, the charging system 1 can appropriately cooperate with the power saving request also at the charging facility 12 at which the jump-in charging is performed.

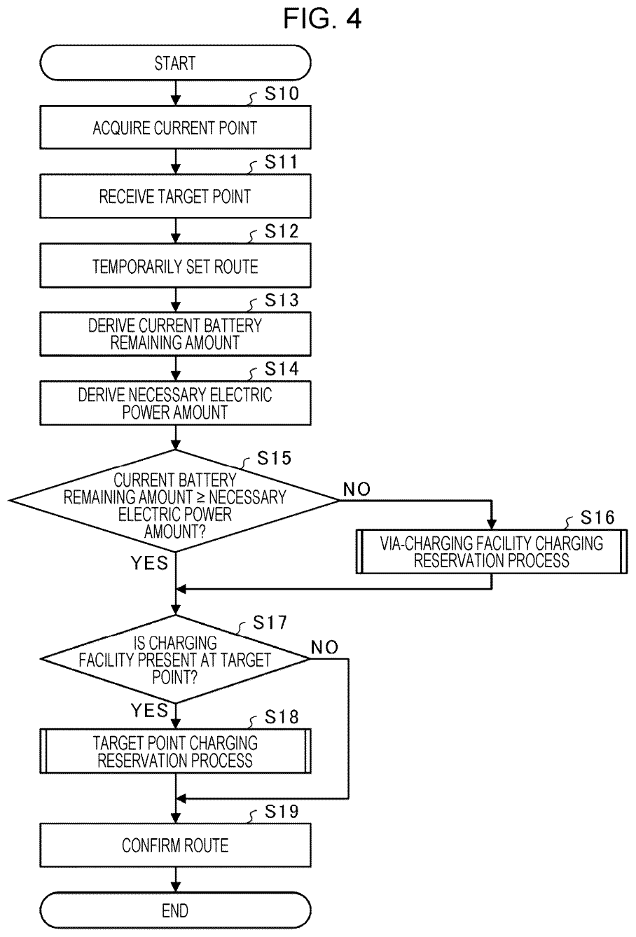

FIG. 4 is a flowchart illustrating an operation flow of the vehicle controller 54. Upon the vehicle controller 54 receiving an operation to start setting a route, the series of steps in FIG. 4 is started.

First, the vehicle controller 54 acquires the current position of the vehicle 10 using the GPS of the navigation device 46 (S10). The vehicle controller 54 receives the target point of the traveling of the vehicle 10 through the touch panel or the like of the navigation device 46 (S11). The vehicle controller 54 temporarily sets the route based on the current point, the target point, and the map information of the navigation device 46 (S12).

The vehicle controller 54 derives the current battery remaining amount based on the current SOC of the in-vehicle battery 42 (S13). The vehicle controller 54 derives the necessary electric power amount based on the distance along the temporarily set route from the current point to the target point (S14). In more detail, the vehicle controller 54 multiplies the average electric power consumption of the vehicle 10 by the distance along the temporarily set route from the current point to the target point, and further multiplies it by a predetermined safety factor to derive the necessary electric power amount (necessary electric power amount=average electric power consumption×distance×safety factor). The safety factor is set to an appropriate value, for example, 1.1.

The vehicle controller 54 determines whether the current battery remaining amount is greater than or equal to the necessary electric power amount (S15). When the current battery remaining amount is less than the necessary electric power amount, the current battery remaining amount is not enough to arrive at the target point, and the vehicle 10 is to be charged in the middle of the route. That is, in step S15, it is determined whether the vehicle 10 is to be charged in the middle of the route.

When the current battery remaining amount is less than the necessary electric power amount (NO in S15), the vehicle controller 54 performs a via-charging facility charging reservation process (S16) for specifying the via-charging facility and reserving the charging at the via-charging facility. The via-charging facility charging reservation process (S16) will be described in detail later. After the via-charging facility charging reservation process (S16), the vehicle controller 54 proceeds to step S17.

When the current battery remaining amount is greater than or equal to the necessary electric power amount (YES in S15), the vehicle controller 54 proceeds to step S17 because it is possible to arrive at the target point without the via-charging facility.

In step S17, the vehicle controller 54 determines whether the charging facility 12 is present at the target point (S17).

When the charging facility 12 is present at the target point (YES in S17), the vehicle controller 54 performs a target point charging reservation process (S18) for reserving the charging at the charging facility at the target point, confirms the temporarily set route (S19), and ends the series of steps. The target point charging reservation process (S18) will be described in detail later.

When the charging facility 12 is not present at the target point (NO in S17), the vehicle controller 54 confirms the temporarily set route (S19), and ends the series of steps.

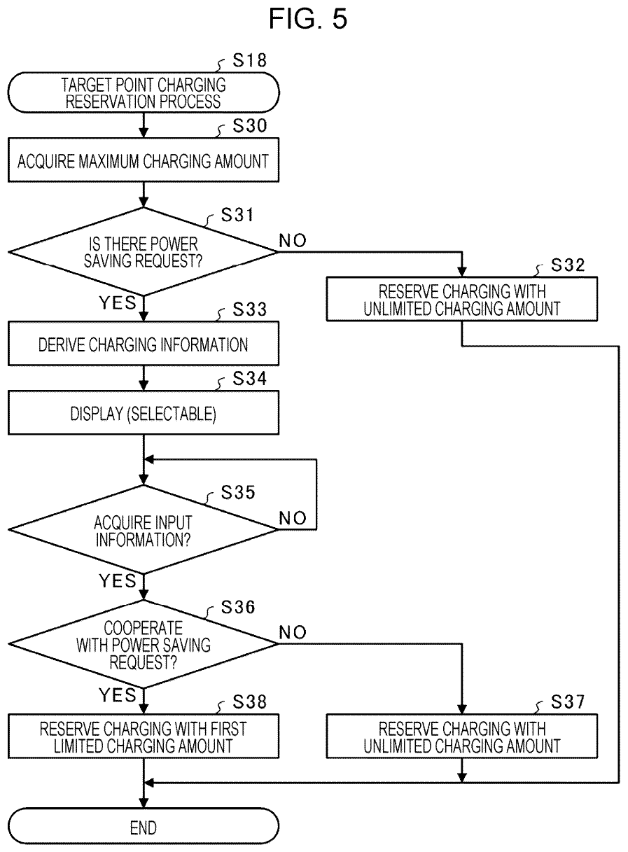

FIG. 5 is a flowchart illustrating a flow of the target point charging reservation process (S18). Upon the start of the target point charging reservation process (S18), the vehicle controller 54 acquires the maximum charging amount of the charging facility 12 at the target point (S30). The maximum charging amount may be acquired directly from the charging facility 12 at the target point or may be acquired indirectly through the server apparatus 14.

The vehicle controller 54 determines whether the power saving request has been issued to the region to which the charging facility 12 at the target point belongs (S31).

When it is determined that the power saving request has not been issued (NO in S31), the vehicle controller 54 transmits, to the server apparatus 14, a reservation request of the charging with an unlimited charging amount at the charging facility 12 at the target point (S32), and ends the target point charging reservation process (S18). In response to this, the server controller 94 makes a reservation with the unlimited charging amount.

When it is determined that the power saving request has been issued (YES in S31), the vehicle controller 54 derives the charging information (S33). In more detail, the vehicle controller 54 derives the charging amount, the charging time, and the forecast cruising distance when the charging amount is limited to the first limited charging amount, and the charging amount, the charging time, and the forecast cruising distance in the normal time.

The vehicle controller 54 causes the display device of the navigation device 46 to display the selection operators, the derived charging information, and the map information of the predetermined range including the target point (S34). The display here includes the selection operators, and an input operation for selecting whether to cooperate with the power saving request can be performed.

The vehicle controller 54 determines whether input information through any of the selection operators is acquired (S35), and waits for the input information to be acquired (NO in S35).

When the input information through any of the selection operators is acquired (YES in S35), the vehicle controller 54 determines whether the content of the acquired input information is a selection result indicating the cooperation with the power saving request (S36).

When it is determined that the selection result indicates the cooperation with the power saving request (YES in S36), the vehicle controller 54 transmits, to the server apparatus 14, a reservation request of the charging with the first limited charging amount at the charging facility 12 at the target point (S38), and ends the target point charging reservation process (S18). In response to this, the server controller 94 makes a reservation with the first limited charging amount.

When it is determined that the selection result indicates no cooperation with the power saving request (NO in S36), the vehicle controller 54 transmits, to the server apparatus 14, a reservation request of the charging with the unlimited charging amount at the charging facility 12 at the target point (S37), and ends the target point charging reservation process (S18). In response to this, the server controller 94 makes a reservation with the unlimited charging amount.

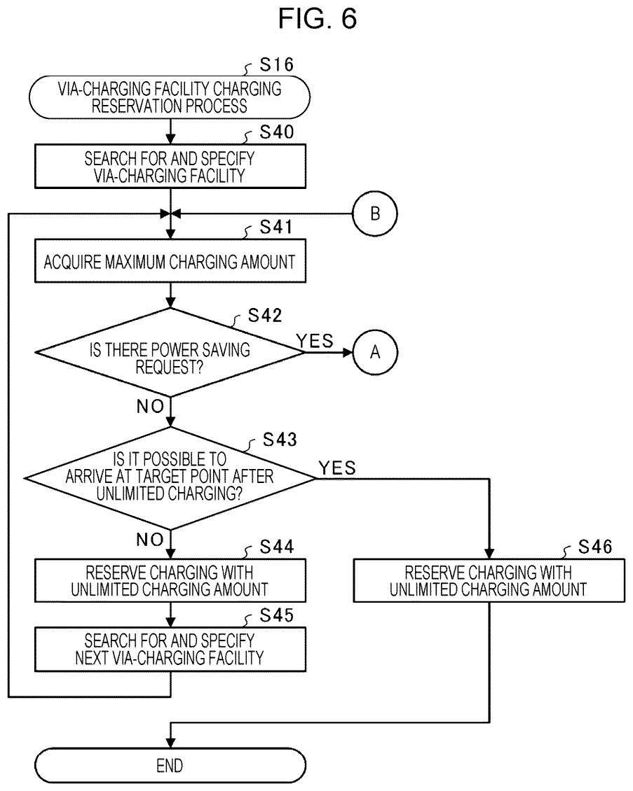

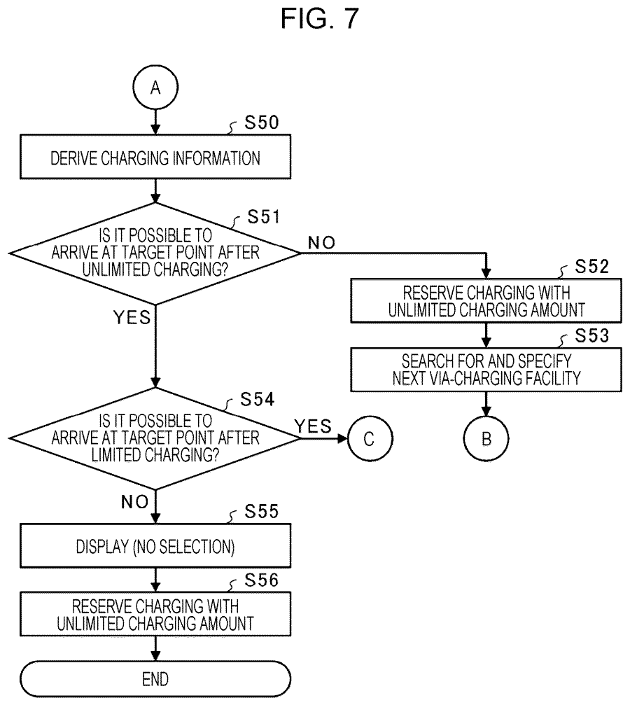

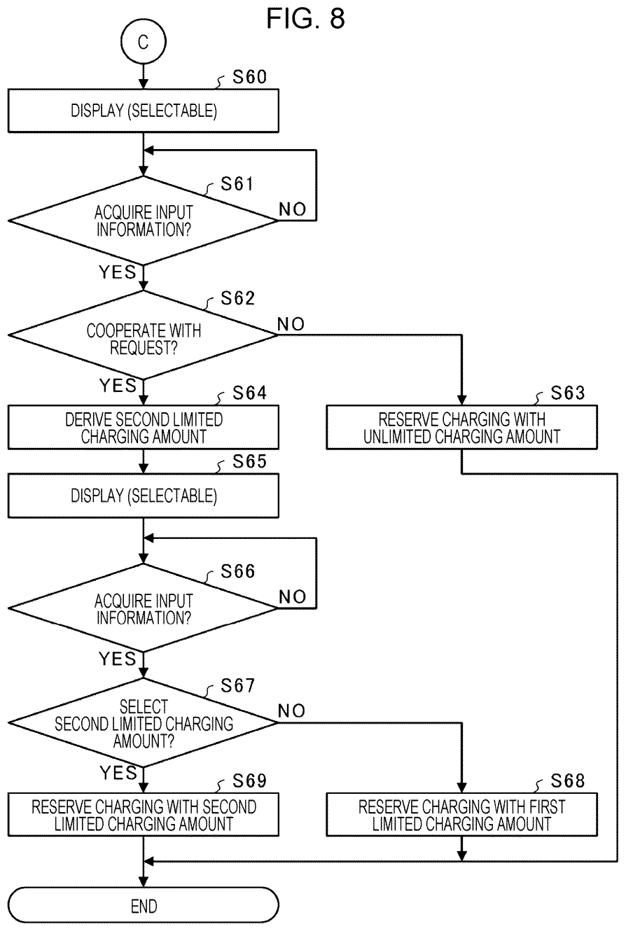

FIG. 6, FIG. 7, and FIG. 8 are flowcharts illustrating a flow of the via-charging facility charging reservation process (S16). “A” in FIG. 6 is linked to “A” in FIG. 7. “B” in FIG. 7 is linked to “B” in FIG. 6. “C” in FIG. 7 is linked to “C” in FIG. 8.

Upon the start of the via-charging facility charging reservation process (S16), the vehicle controller 54 searches for via-charging facilities within a travelable range with the current battery remaining amount, and specifies the via-charging facility along the temporarily set route from among the extracted via-charging facilities (S40). The vehicle controller 54 acquires the maximum charging amount of the specified via-charging facility (S41).

The vehicle controller 54 determines whether the power saving request has been issued to the region to which the specified via-charging facility belongs (S42).

When it is determined that the power saving request has not been issued (NO in S42), the vehicle controller 54 determines whether the arrival at the target point is possible after unlimited charging (S43).

When it is determined that the arrival at the target point is not possible (NO in S43), the vehicle controller 54 requests the reservation of the charging with the unlimited charging amount at the specified via-charging facility (S44). In response to this, the server controller 94 makes a reservation with the unlimited charging amount.

Since the arrival at the target point is not possible after the unlimited charging, the vehicle controller 54 searches for the next via-charging facility within the travelable range with the amount of electric power remaining in the in-vehicle battery 42 after the charging. The vehicle controller 54 specifies, as the next via-charging facility, the via-charging facility along the temporarily set route among the extracted via-charging facilities (S45).

The vehicle controller 54 acquires the maximum charging amount of the next via-charging facility specified in step S45 (S41), and repeats step S42 and the subsequent steps for the next via-charging facility. In this way, the vehicle controller 54 specifies the via-charging facility and reserves the charging at the specified via-charging facility until the arrival at the target point becomes possible.

When it is determined that the arrival at the target point is possible after the unlimited charging (YES in S43), the vehicle controller 54 reserves the charging with the unlimited charging amount at the most recently specified via-charging facility, that is, the final via-charging facility (S46). In response to this, the server controller 94 makes a reservation with the unlimited charging amount. After step S46, the vehicle controller 54 ends the via-charging facility charging reservation process (S16).

When it is determined in step S42 that the power saving request has been issued (YES in S42), the vehicle controller 54 proceeds from “A” in FIG. 6 to “A” in FIG. 7, and derives the charging information of the specified via-charging facility (S50). In more detail, the vehicle controller 54 derives the charging amount, the charging time, and the forecast cruising distance when the charging amount is limited to the first limited charging amount, and the charging amount, the charging time, and the forecast cruising distance in the normal time.

The vehicle controller 54 determines whether the arrival at the target point is possible after the unlimited charging at the specified via-charging facility (S51).

When it is determined that the arrival at the target point is not possible after the unlimited charging (NO in S51), the vehicle controller 54 transmits, to the server apparatus 14, a reservation request of the charging with the unlimited charging amount at the specified via-charging facility (S52). In response to this, the server controller 94 makes a reservation with the unlimited charging amount.

Since the arrival at the target point is not possible after the unlimited charging, the vehicle controller 54 searches for the next via-charging facility within the travelable range with the amount of electric power remaining in the in-vehicle battery 42 after the charging. The vehicle controller 54 specifies, as the next via-charging facility, the via-charging facility along the temporarily set route among the extracted via-charging facilities (S53). Subsequently, the vehicle controller 54 proceeds from “B” in FIG. 7 to “B” in FIG. 6.

The vehicle controller 54 acquires the maximum charging amount of the next via-charging facility specified in step S53 (S41), and repeats step S42 and the subsequent steps for the next via-charging facility. In this way, the vehicle controller 54 specifies the via-charging facility and reserves the charging at the specified via-charging facility until the arrival at the target point becomes possible.

Here, each time the via-charging facility is specified, it is determined whether the power saving request has been issued to the region to which the specified via-charging facility belongs (S42). However, a control flow may be such that the vehicle controller 54 determines whether the power saving request has been issued for the final via-charging facility alone, and omits the determination as to whether the power saving request has been issued for the non-final via-charging facility.

When it is determined in step S51 that the arrival at the target point is possible after the unlimited charging (YES in S51), the vehicle controller 54 determines whether the arrival at the target point is possible after limited charging (S54).

When it is determined that the arrival at the target point is not possible after the limited charging (NO in S54), the arrival at the target point from the final via-charging facility is not possible if the limitation of the charging amount at the final via-charging facility is permitted. Thus, in this case, the vehicle controller 54 causes the display device of the navigation device 46 to display a message indicating no cooperation with the power saving request (S55). The display here does not include the selection operators, and the input operation for selecting whether to cooperate with the power saving request is disabled.

In order not to cooperate with the power saving request, the vehicle controller 54 transmits, to the server apparatus 14, a reservation request of the charging with the unlimited charging amount at the final via-charging facility (S56), and ends the via-charging facility charging reservation process (S16). In response to this, the server controller 94 makes a reservation with the unlimited charging amount.

When it is determined in step S54 that the arrival at the target point is possible after the limited charging (YES in S54), the process proceeds from “C” in FIG. 7 to “C” in FIG. 8. In this case, the power saving request has been issued to the region to which the final via-charging facility belongs, and the arrival at the target point is possible even if the limited charging is performed at the final via-charging facility.

Thus, the vehicle controller 54 causes the display device of the navigation device 46 to display the selection operators, the derived charging information, and the map information of the predetermined range including the target point (S60). The display here includes the selection operators, and the input operation for selecting whether to cooperate with the power saving request can be performed.

The vehicle controller 54 determines whether input information through any of the selection operators is acquired (S61), and waits for the input information to be acquired (NO in S61).

When the input information through any of the selection operators is acquired (YES in S61), the vehicle controller 54 determines whether the content of the acquired input information is a selection result indicating the cooperation with the power saving request (S62).

When it is determined that the selection result indicates no cooperation with the power saving request (NO in S62), the vehicle controller 54 transmits, to the server apparatus 14, a reservation request of the charging with the unlimited charging amount at the final via-charging facility (S63), and ends the via-charging facility charging reservation process (S16). In response to this, the server controller 94 makes a reservation with the unlimited charging amount.

When it is determined that the selection result indicates the cooperation with the power saving request (YES in S62), the vehicle controller 54 derives the second limited charging amount (S64). For example, the vehicle controller 54 adds the charging amount at the non-final via-charging facility to the current battery remaining amount, and estimates the amount of electric power remaining in the in-vehicle battery 42 at the arrival at the final via-charging facility. The vehicle controller 54 subtracts, from the necessary electric power amount, the amount of electric power remaining in the in-vehicle battery 42 at the arrival at the final via-charging facility to derive the second limited charging amount.

The vehicle controller 54 causes the display device of the navigation device 46 to display the first limited charging amount and the second limited charging amount (S65). The display here includes limitation selection operators for receiving selection of which of the first limited charging amount and the second limited charging amount is used for the charging. Thus, it is possible to perform an input operation for selecting which one of the first limited charging amount and the second limited charging amount is used for the charging.

The vehicle controller 54 determines whether input information through any of the limitation selection operators is acquired (S66), and waits for the input information to be acquired (NO in S66).

When the input information through any of the limitation selection operators is acquired (YES in S66), the vehicle controller 54 determines whether the content of the acquired input information is a selection result for selecting the second limited charging amount (S67).

When it is determined that the selection result indicates no selection of the second limited charging amount (NO in S67), the vehicle controller 54 transmits, to the server apparatus 14, a reservation request of the charging with the first limited charging amount at the final via-charging facility (S68), and ends the via-charging facility charging reservation process (S16). In response to this, the server controller 94 makes a reservation with the first limited charging amount.

When it is determined that the selection result indicates the selection of the second limited charging amount (YES in S67), the vehicle controller 54 transmits, to the server apparatus 14, a reservation request of the charging with the second limited charging amount at the final via-charging facility (S69), and ends the via-charging facility charging reservation process (S16). In response to this, the server controller 94 makes a reservation with the second limited charging amount.

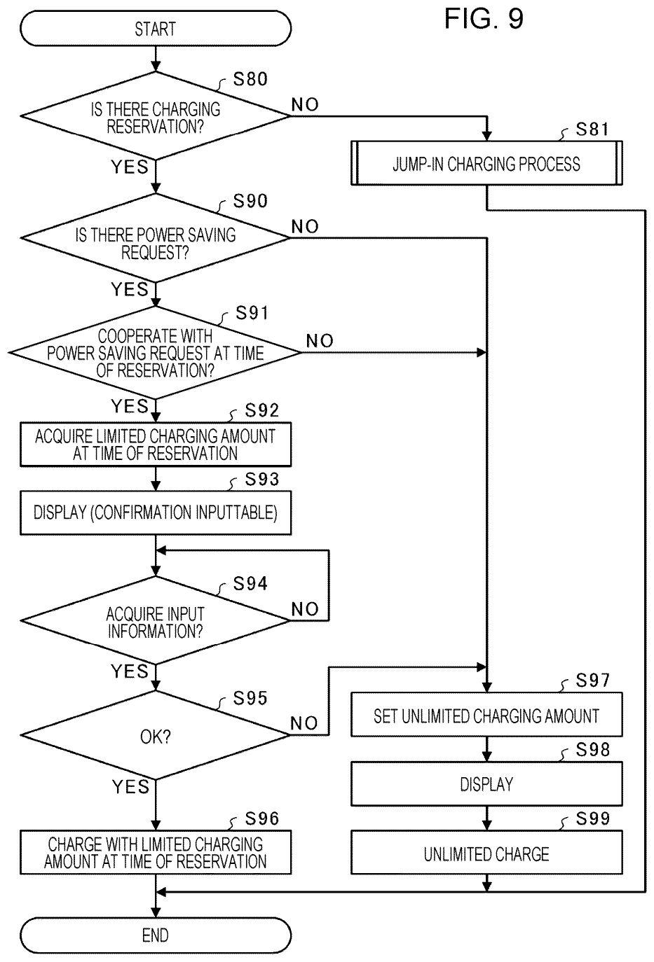

FIG. 9 is a flowchart illustrating a process flow at the start of the charging. The vehicle controller 54 performs the series of steps in FIG. 9 at a timing when the vehicle 10 enters a charging area in which the charging facility 12 is installed. For example, when the charging facility 12 is installed in a rest area, a part of the rest area in which the charging facility 12 is installed may be set as the charging area. Hereinafter, for convenience of description, the charging facility 12 in the charging area where the vehicle 10 has entered may be referred to as a target charging facility 12. The target charging facility 12 may be the charging facility 12 at the target point or may be the via-charging facility.

First, the vehicle controller 54 communicates with the server apparatus 14, and determines whether the charging at the target charging facility 12 is reserved (S80). When it is determined that the charging is not reserved (NO in S80), the vehicle controller 54 performs a jump-in charging process (S81) for performing the jump-in charging, and ends the series of steps in FIG. 9. The jump-in charging process (S81) will be described in detail later.

When it is determined that the charging is reserved (YES in S80), the vehicle controller 54 determines whether the power saving request has been issued to the region to which the target charging facility 12 belongs (S90).

When it is determined that the power saving request has been issued (YES in S90), the vehicle controller 54 determines whether the selection result indicating the cooperation with the power saving request is acquired at the time of reservation of the target charging facility 12 (S91).

When it is determined that the selection result indicating the cooperation with the power saving request is acquired (YES in S91), the vehicle controller 54 acquires the limited charging amount at the time of reservation of the target charging facility 12 (S92). For example, the vehicle controller 54 acquires the first limited charging amount when the charging with the first limited charging amount is reserved, and acquires the second limited charging amount when the charging with the second limited charging amount is reserved.

The vehicle controller 54 causes the display device of the navigation device 46 to display the acquired limited charging amount at the time of reservation (S93). In this display, it is possible to input a confirmation as to whether the charging with the limited charging amount being displayed may be started.

The vehicle controller 54 determines whether input information indicating the confirmation is acquired (S94), and waits for the input information to be acquired (NO in S94).

When the input information indicating the confirmation is acquired (YES in S94), the vehicle controller 54 determines whether the content of the acquired input information permits the charging with the limited charging amount being displayed (S95).

When it is determined that the charging with the limited charging amount being displayed is permitted (YES in S95), the vehicle controller 54 causes the target charging facility 12 to start the charging with the limited charging amount at the time of reservation (S96), and ends the series of steps in FIG. 9.

When it is determined in step S90 that the power saving request has not been issued (NO in S90), the vehicle controller 54 proceeds to step S97. Alternatively, when it is determined in step S91 that the selection result indicating no cooperation with the power saving request is acquired (NO in S91), the vehicle controller 54 proceeds to step S97. Alternatively, when it is determined in step S95 that the charging with the limited charging amount being displayed is not permitted (NO in S95), the vehicle controller 54 proceeds to step S97.

In step S97, the vehicle controller 54 causes the target charging facility 12 to set the unlimited charging amount (S97). For example, the vehicle controller 54 may cause the maximum charging amount of the target charging facility 12 to be set as the charging amount for the charging. Alternatively, the vehicle controller 54 may cause a charging amount registered in advance by the occupant to be set as the charging amount for the charging.

The vehicle controller 54 causes the display device of the navigation device 46 to display the set charging amount (S98). The vehicle controller 54 causes the target charging facility 12 to start the charging with the unlimited charging amount, that is, the charging amount that is set in step S97 (S99), and ends the series of steps in FIG. 9.

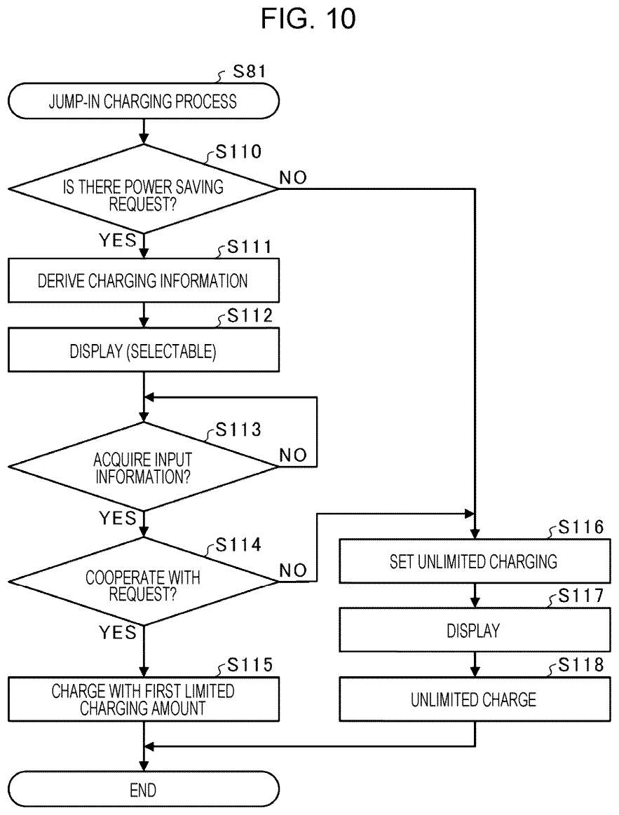

FIG. 10 is a flowchart illustrating a flow of the jump-in charging process (S81). Upon the start of the jump-in charging process (S81), the vehicle controller 54 determines whether the power saving request has been issued to the region to which the target charging facility 12 belongs (S110).

When it is determined that the power saving request has been issued (YES in S110), the vehicle controller 54 derives the charging information of the target charging facility 12 (S111). In more detail, the vehicle controller 54 derives the charging amount, the charging time, and the forecast cruising distance when the charging amount is limited to the first limited charging amount, and the charging amount, the charging time, and the forecast cruising distance in the normal time.

The vehicle controller 54 causes the display device of the navigation device 46 to display the selection operators, the derived charging information, and the map information of the predetermined range including the target charging facility (S112). The display here includes the selection operators, and the input operation for selecting whether to cooperate with the power saving request can be performed.

The vehicle controller 54 determines whether input information through any of the selection operators is acquired (S113), and waits for the input information to be acquired (NO in S113).

When the input information through any of the selection operators is acquired (YES in S113), the vehicle controller 54 determines whether the content of the acquired input information is a selection result indicating the cooperation with the power saving request (S114).

When it is determined that the selection result indicates the cooperation with the power saving request (YES in S114), the vehicle controller 54 causes the target charging facility 12 to start the charging with the first limited charging amount (S115), and ends the jump-in charging process (S81).

In the jump-in charging process (S81), when the selection result indicating the cooperation with the power saving request is acquired, the vehicle controller 54 may encourage selection of the first limited charging amount or the second limited charging amount. In this embodiment, the vehicle controller 54 may cause the target charging facility 12 to start the charging with the charging amount selected from the first limited charging amount and the second limited charging amount.

When it is determined in step S110 that the power saving request has not been issued (NO in S110), the vehicle controller 54 proceeds to step S116. Alternatively, when it is determined in step S114 that the selection result indicates no cooperation with the power saving request (NO in S114), the vehicle controller 54 proceeds to step S116.

In step S116, the vehicle controller 54 causes the target charging facility 12 to set the unlimited charging amount (S116). For example, the vehicle controller 54 may cause the maximum charging amount of the target charging facility 12 to be set as the charging amount for the charging. Alternatively, the vehicle controller 54 may cause a charging amount registered in advance by the occupant to be set as the charging amount for the charging.

The vehicle controller 54 causes the display device of the navigation device 46 to display the set charging amount (S117). The vehicle controller 54 causes the target charging facility 12 to start the charging with the unlimited charging amount, that is, the charging amount that is set in step S116 (S118), and ends the jump-in charging process (S81).

As described above, in the charging system 1 of the embodiment, it is determined whether the power saving request has been issued to the region to which the charging facility 12 belongs. In the charging system 1 of the embodiment, when it is determined that the power saving request has been issued, the occupant of the vehicle 10 is encouraged to select whether to cooperate with the power saving request. In the charging system 1 of the embodiment, when the selection result indicating the cooperation with the power saving request is acquired, the limitation of the charging amount with which the vehicle 10 is charged from the charging facility 12 is permitted, differently with the case of not cooperating with the power saving request.

Accordingly, in the charging system 1 of the embodiment, it is possible to suppress the charging amount used at the charging facility 12 in response to the issuance of the power saving request to the region to which the charging facility 12 belongs. Accordingly, in the charging system 1 of the embodiment, it is possible to appropriately cooperate with the power saving request at the charging facility 12.

In addition, in the charging system 1 of the embodiment, by encouraging the occupant to select whether to cooperate with the power saving request, it is possible to appropriately cooperate with the power saving request and avoid a situation in which the traveling intended by the occupant is hindered by the limitation of the charging amount due to the power saving request.

Therefore, according to the charging system 1 of the embodiment, even when the power saving request is issued to the region to which the charging facility 12 belongs, it is possible to appropriately charge the vehicle 10 at the charging facility 12.

Although the embodiment of the disclosure has been described above with reference to the accompanying drawings, the disclosure is not limited to the embodiment. It is clear that those skilled in the art can conceive of various modifications or corrections within the scope described in the claims. It is to be understood that these are naturally included in the technical scope of the disclosure.

The series of steps performed by each apparatus (for example, the vehicle 10 or the server apparatus 14) according to the embodiment described above may be implemented by using any of software, hardware, or a combination of software and hardware. A program constituting the software is stored in advance in, for example, a non-transitory medium provided inside or outside each apparatus. For example, the program is read from the non-transitory medium (for example, a ROM) to a transitory medium (for example, a RAM) and executed by a processor such as a central processing unit (CPU).

It is possible to create a program for implementing each function of each apparatus and install the program in a computer of each apparatus. When the processor executes the program stored in the memory, the processing of each function described above is executed. At this time, the program may be shared and executed by processors, or the program may be executed by a single processor. In addition, each function of each apparatus may be implemented by cloud computing using computers coupled to each other via a communication network. Note that the program may be provided to and installed in the computer of each apparatus by being distributed from an external apparatus via a communication network.

According to the disclosure, the charging can be appropriately performed even when the power saving request is issued.

1. A charging system comprising:
a vehicle comprising an in-vehicle battery and a control device; and
a charging facility capable of charging the vehicle, wherein
the control device comprises:
one or more processors; and
one or more memories coupled to the one or more processors, and
the one or more processors are configured to perform processing comprising:
determining whether a power saving request has been issued to a region to which the charging facility belongs;
when the power saving request is determined to have been issued, encouraging an occupant of the vehicle to perform a selection to select whether to cooperate with the power saving request;
when a result of the selection indicating cooperation with the power saving request is acquired, encouraging the occupant of the vehicle to select whether to charge the vehicle with a first limited charging amount, which is a charging amount with which the vehicle is charged from the charging facility and which is limited based on the power saving request differently a case of not cooperating with the power saving request, or a second limited charging amount, which is a charging amount more limited than the first limited charging amount; and
permitting limitation of the charging amount with which the vehicle is charged from the charging facility, based on selected one of the first limited charging amount and the second limited charging amount.

2. The charging system according to claim 1, wherein
the one or more processors are configured to perform processing comprising:
in the encouraging the occupant of the vehicle to select whether to cooperate with the power saving request,
displaying any one or more of the charging amount, a charging time, and a forecast cruising distance on an assumption to cooperate with the power saving request, or
displaying any one or more of the charging amount, the charging time, and the forecast cruising distance on the assumption to cooperate with the power saving request, and any one or more of the charging amount, the charging time, and the forecast cruising distance on an assumption to not cooperate with the power saving request.

3. The charging system according to claim 1, wherein
the one or more processors are configured to perform processing comprising:
receiving setting of a target point of traveling;
determining whether the charging facility is installed at the target point;
when the charging facility is determined to be installed at the target point, determining whether the power saving request has been issued to the region to which the charging facility at the target point belongs;
when the power saving request is determined to have been issued, encouraging the occupant of the vehicle to perform a selection to select whether to cooperate with the power saving request; and
when the result of the selection indicating the cooperation with the power saving request is acquired, permitting the limitation of the charging amount with which the vehicle is charged from the charging facility at the target point, differently from the case of not cooperating with the power saving request.

4. The charging system according to claim 1, wherein
the one or more processors are configured to perform processing comprising:
receiving setting of a target point of traveling; and
setting a route from a current point to the target point, and
the one or more processors are configured to perform processing comprising:
in the setting the route,
determining whether the vehicle is to be charged in a middle of the route;
when the vehicle is determined to be charged in the middle of the route, specifying a via-charging facility, which is the charging facility in the middle of the route;
determining whether the power saving request has been issued to a region to which the via-charging facility belongs;
when the power saving request is determined to have been issued, encouraging the occupant of the vehicle to perform a selection to select whether to cooperate with the power saving request; and
when the result of the selection indicating the cooperation with the power saving request is acquired, permitting the limitation of the charging amount with which the vehicle is charged from the via-charging facility differently from the case of not cooperating with the power saving request.

5. The charging system according to claim 4, wherein
the one or more processors are configured to perform processing comprising:
when the power saving request is determined to have been issued to the region to which the via-charging facility belongs,
determining whether the vehicle is able to arrive at the target point even when the vehicle is charged from the via-charging facility with the charging amount limited based on the power saving request; and
when the vehicle is determined to be not able to arrive at the target point by the charging with the limited charging amount, not permitting the limitation of the charging amount with which the vehicle is charged from the via-charging facility even when the power saving request is determined to have been issued.

6. The charging system according to claim 4, wherein
the one or more processors are configured to perform processing comprising:
when charging is specified to be performed at via-charging facilities comprising the via-charging facility, at a via-charging facility other than a via-charging facility closest to the target point along the route among the via-charging facilities, not permitting the limitation of the charging amount with which the vehicle is charged from the via-charging facility even when the power saving request is determined to have been issued.

7. A charging system comprising:
a vehicle comprising an in-vehicle battery and a control device; and
a charging facility capable of charging the vehicle, wherein
the control device comprises:
one or more processors; and
one or more memories coupled to the one or more processors,
the one or more processors are configured to perform processing comprising:
receiving setting of a target point of traveling;
setting a route from a current point to the target point;
determining whether a power saving request has been issued to a region to which the charging facility belongs;
when the power saving request is determined to have been issued, encouraging an occupant of the vehicle to perform a selection to select whether to cooperate with the power saving request; and
when a result of the selection indicating cooperation with the power saving request is acquired, permitting limitation of a charging amount with which the vehicle is charged from the charging facility as compared with a case of not cooperating with the power saving request,
the one or more processors are configured to perform processing comprising:
in the setting the route,
determining whether the vehicle is to be charged in a middle of the route;
when the vehicle is determined to be charged in the middle of the route, specifying a via-charging facility, which is the charging facility in the middle of the route;
determining whether the power saving request has been issued to a region to which the via-charging facility belongs;
when the power saving request is determined to have been issued, encouraging the occupant of the vehicle to select whether to cooperate with the power saving request; and
when the result of the selection indicating the cooperation with the power saving request is acquired, permitting the limitation of the charging amount with which the vehicle is charged from the via-charging facility as compared with the case of not cooperating with the power saving request, and
the one or more processors are configured to perform processing comprising:
when the power saving request is determined to have been issued to the region to which the via-charging facility belongs,
determining whether the vehicle is able to arrive at the target point even when the vehicle is charged from the via-charging facility with the charging amount limited based on the power saving request; and
when the vehicle is determined to be not able to arrive at the target point by the charging with the limited charging amount, not permitting the limitation of the charging amount with which the vehicle is charged from the via-charging facility even when the power saving request is determined to have been issued.

8. A charging system comprising:
a vehicle comprising an in-vehicle battery and a control device; and
a charging facility capable of charging the vehicle, wherein
the control device comprises:
one or more processors; and
one or more memories coupled to the one or more processors,
the one or more processors are configured to perform processing comprising:
receiving setting of a target point of traveling;
setting a route from a current point to the target point;
determining whether a power saving request has been issued to a region to which the charging facility belongs;
when the power saving request is determined to have been issued, encouraging an occupant of the vehicle to perform a selection to select whether to cooperate with the power saving request; and
when a result of the selection indicating cooperation with the power saving request is acquired, permitting limitation of a charging amount with which the vehicle is charged from the charging facility as compared with a case of not cooperating with the power saving request,
the one or more processors are configured to perform processing comprising:
in the setting the route,
determining whether the vehicle is to be charged in a middle of the route;
when the vehicle is determined to be charged in the middle of the route, specifying a via-charging facility, which is the charging facility in the middle of the route;
determining whether the power saving request has been issued to a region to which the via-charging facility belongs;
when the power saving request is determined to have been issued, encouraging the occupant of the vehicle to select whether to cooperate with the power saving request; and
when the result of the selection result indicating the cooperation with the power saving request is acquired, permitting the limitation of the charging amount with which the vehicle is charged from the via-charging facility as compared with the case of not cooperating with the power saving request, and
the one or more processors are configured to perform processing comprising:
when charging is specified to be performed at via-charging facilities comprising the via-charging facility, at a via-charging facility other than a via-charging facility closest to the target point along the route among the via-charging facilities, not permitting the limitation of the charging amount with which the vehicle is charged from the via-charging facility even when the power saving request is determined to have been issued.
